(19) United States
(12) Patent Application Publication
(10) Pub. No.: US 2024/0357952 A1
(43) Pub. Date: Oct. 31, 2024

(54) SYSTEM AND METHOD TO DETERMINE MOWING RAKING AND BALING TIMES

(71) Applicant: CNH Industrial America LLC, New Holland, PA (US)

(72) Inventors: Samuel Anderson, New Holland, PA (US); Kevin Hanson, New Holland, PA (US); Jeffrey Fay, II, New Holland, PA (US)

(73) Assignee: CNH Industrial America LLC, New Holland, PA (US)

(21) Appl. No.: 18/139,899

(22) Filed: Apr. 26, 2023

(51) Int. Cl. A01B 79/00

(52) U.S. Cl. CPC A01B 79/005

(57) ABSTRACT

A system and method for crop monitoring is disclosed. The system includes support towers configured to irrigate a crop, wheels coupled to the support towers, a water conduit extending between the support towers, a truss system extending between the support towers and supporting the water conduit, nozzles, a sensor array, and a controller. The nozzles are fluidly coupled to the water conduit. The sensor array is configured to collect data associated with a parameter of the crop. The controller is communicatively coupled to the sensor array. The controller includes a processor and a memory. The memory contains instructions that, when executed by the processor, cause the processor to perform steps that include receiving the data associated with a parameter of the crop, determining at least one action item corresponding to data associated with the parameter of the crop, and sending a signal indicating that the action item should be performed.

### BACKGROUND

Most crop monitoring is done by farmers driving to look at their fields and estimating whether it is time to perform a task. Multiple factors such as temperature, weather, crop height, crop bloom, time since mowing, and moisture content affect the optimum time to perform a given task. Moisture content, for example, is particularly challenging to determine because it can vary across a field and is usually measured by hand. Systems and methods to more uniformly and accurately monitor crop conditions are needed to provide optimum scheduling of mowing, raking, baling, harvesting, and other tasks for crop management.

### SUMMARY

One embodiment relates to a system for crop monitoring. The system for crop monitoring includes a plurality of support towers configured to irrigate a crop, a plurality of wheels, each wheel coupled to one of the support towers, a water conduit extending between the plurality of support towers, a truss system extending between the plurality of support towers and supporting the water conduit, a plurality of nozzles, a sensor array, and a controller. Each of the nozzles is fluidly coupled to the water conduit. The sensor array is configured to collect data associated with a parameter of the crop. The controller is communicatively coupled to the sensor array. The controller includes a processor and a memory. The memory contains instructions that, when executed by the processor, cause the processor to perform steps that include receiving data associated with a parameter of the crop, determining at least one action item corresponding to data associated with the parameter of the crop, and sending a signal indicating that the action item should be performed.

In some embodiments, the sensor array includes at least one of a first sensor, a second sensor, a third sensor, a forth sensor, and a fifth sensor. The first sensor is coupled to one of the support towers. The second sensor is coupled to one of the wheels. The third sensor is coupled to the water conduit. The fourth sensor is coupled to the truss system. The fifth sensor is coupled to one of the nozzles.

In some aspects, the system includes a drag line fluidly connecting the water conduit to at least one of the nozzles. In such embodiments, the sensor array may include at least one of a drag line sensor coupled to the drag line.

In particular embodiments, when the sensor array collects data associated with a parameter of the crop, the parameter of the crop includes at least one of a crop height, a crop bloom, a crop moisture content, an air humidity content, a soil moisture content, a crop color, a crop growth stage, a crop identifier, or a soil fertilizer content.

In particular embodiments, the at least one action item corresponding to data associated with the parameter of the crop includes at least one of an indication that the crop should be watered, an indication that the crop should be mowed, an indication that the crop should be tedded, an indication that the crop should be raked, an indication that the crop should be chemically treated, an indication that the crop should be baled, or an indication that the crop should be left alone.

In further embodiments, the memory contains instructions that, when executed by the processor, cause the processor to estimate a wait time until at least one action item corresponding to data associated with the parameter of the crop should be performed. Additionally, the processor may send a signal indicative of the wait time.

In some embodiments, the memory contains instructions that, when executed by the processor, cause the processor to receive an indication of a crop attribute. In some aspects, the processor also estimates a dry down time for the crop.

In particular embodiments, when the processor receives an indication of a crop attribute, the crop attribute includes at least one of a crop type, a crop age, a crop planted date, or a harvest stage indication.

In some aspects, a user interface communicatively coupled to the controller sends the indication of a crop attribute to the controller following a user input.

Another embodiment relates to a method for crop monitoring. The method includes receiving at a controller data associated with a parameter of the crop, determining at least one action item corresponding to data associated with the parameter of the crop, and sending a signal indicating that the action item should be performed.

In particular embodiments, the method also includes estimating a wait time until the least one action item corresponding to data associated with the parameter of the crop should be performed, and sending a signal indicative of the wait time.

In other embodiments, the method includes receiving at the controller an indication of a crop attribute, and estimating a dry down time for the crop. In some aspects, the indication of a crop attribute is received via a user inputting data on a user interface communicatively coupled to the controller.

In some embodiments, when the method determines at least one action item corresponding to data associated with the parameter of the crop, the method determines at least one of: whether the crop should be watered, whether the crop should be mowed, whether the crop should be tedded, whether the crop should be raked, whether the crop should be chemically treated, whether the crop should be baled, or whether the crop should be left alone.

In another embodiment, a system for crop monitoring includes a plurality of support towers configured to irrigate a crop, a plurality of wheels with each wheel coupled to one of the support towers, a water conduit extending between the support towers, a truss system extending between support towers and configured to support the water conduit, and a plurality of nozzles with each nozzle fluidly coupled to the water conduit. The system also includes a soil moisture sensor coupled to at least one of the wheels and configured to measure data indicating a soil water content. Additionally, the system includes a crop moisture sensor coupled to at least one of the support towers, water conduit, truss system, or nozzles, the moisture sensor configured to collect data indicating humidity in air above the crop. Further, the system includes a controller communicatively coupled to the soil moisture sensor and the crop moisture sensor, the controller comprising a processor and a memory. The memory contains instructions that, when executed by the processor, cause the processor to perform steps including: receiving the data from the soil moisture sensor and the crop moisture sensor, determining at least one of whether the crop should be watered, whether the crop should be mowed, whether the crop should be tedded, whether the crop should be raked, whether the crop should be chemically treated, whether the crop should be baled, whether the crop should be left alone, and sending a signal indicating the determination to a user interface.

In other aspects, the crop monitoring system also includes a height sensor coupled to at least one of the support towers, water conduit, truss system, or nozzles. The height sensor is configured to collect data indicating a height of the crop. The controller is communicatively coupled to the height sensor and the processor receives the data from the height sensor.

In additional embodiments, the crop monitoring system includes a color sensor coupled to at least one of the support towers, water conduit, truss system, or nozzles. The color sensor collects data indicating a color of the crop. The controller is communicatively coupled to the color sensor. The processor receives the data from the color sensor. In particular embodiments, the processor estimates a dry down time of the crop.

In some embodiments, upon determining that the crop should be left alone, the processor estimates a wait time associated with at least one of whether the crop should be watered, whether the crop should be mowed, whether the crop should be tedded, whether the crop should be raked, whether the crop should be chemically treated, or whether the crop should be baled.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a diagram of a crop monitoring system, according to an exemplary embodiment.

FIG. 2 is an alternative diagram of a crop monitoring system, according to an exemplary embodiment.

FIG. 3 is a block diagram of a crop monitoring system, according to an exemplary embodiment.

FIG. 4 is a flow chart depicting exemplary steps of a method for crop monitoring, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a crop monitoring system of the present disclosure includes a plurality of support towers. The plurality of support towers may span the length of the field and are configured to irrigate a crop. In some embodiments, the support towers travel in a linear motion across the field while irrigating the crop (e.g., a linear irrigation system). In other embodiments, the support towers are coupled to a fixed pivot and travel radially around the pivot to irrigate a crop in a substantially circular shape (e.g., a central-pivot irrigation system).

The system also includes a plurality of wheels with each wheel coupled to one of the support towers. A driving mechanism (e.g., a motor, an electric motor, etc.) may be configured to rotate one or more of the wheels. The driving mechanism causes the wheels to rotate, allowing the support towers and the crop monitoring system to travel along the field (e.g., travel linearly over a crop along the length of the field, travel radially over a crop while rotating around a center pivot, etc.). A water conduit extends between the plurality of support towers. The water conduit (e.g., a pipe, hose, etc.) conveys pressurized water from a water source to the crop monitoring system to irrigate the crop. For a linear irrigation system, the water source includes a channel running along the length of the field, a cart configured to move parallel to the channel, and a pump to deliver water from the channel to the water conduit of the crop monitoring system. In other embodiments, a hose system spans the length of the field and supplies water to the crop monitoring system as it travels over the crop. In a central-pivot system, the central pivot point is fluidly coupled to a tank, well, pipe system, groundwater system, etc. to supply water to the water conduit.

The crop monitoring system also includes a truss system extending between the plurality of support towers and supporting the water conduit. For example, the truss system may include truss braces and truss bars configured to provide structural support to both the water conduit and the support towers. In some embodiments, support wires, cable, beams, and/or braces are used to support the water conduit and to couple the water conduit and support towers together.

Additionally, a plurality of nozzles is fluidly coupled to the water conduit. In some embodiments, a hose, pipe, valve, etc. connects the nozzles to the water conduit. The nozzles may be connected such that a “gooseneck” (a u-shaped line extending upward before curving downward towards the crop) is formed in the connector between the water conduit and the nozzles. In other embodiments, the nozzles are connected to the water conduit in a “double gooseneck” formation with two lines extending from the conduit via a substantially U-shape connector in to directions at a single connection point. In some embodiments, a drag line may be deployed to irrigate the crop using a nozzle such as a bubbler, nozzle coupled to a drag sock, etc. The water conduit and nozzles may be directly coupled to one another (e.g., using high pressure sprayers), may be coupled in a mid elevation sprinkler application (MESA) configuration, may be coupled in a low elevation spray application (LESA) configuration, may be coupled in a low elevation precision application (LEPA) configuration, etc.

The system also includes a sensor array. The sensor array is configured to collect data associated with a parameter of the crop. The sensor array includes sensors that are coupled to the wheels, support towers, truss system, nozzles, drag line, and/or water conduit. The sensors may detect a moisture content of the soil, a moisture content of the crop, a moisture content of the air around the crop, a change in humidity of the air above the crop, a color of the crop, a bloom of the crop, a height of the crop, a growth rate/stage of the crop, a crop identifier, a fertilizer content of the soil, or other metrics to aid monitoring the crop to determine the optimal timing of crop related tasks (e.g., watering, chemical treating, mowing, tedding, raking, baling, etc.).

The system includes a controller communicatively coupled to the sensor array. The controller includes a processor and a memory. The memory contains instructions that, when executed by the processor, cause the processor to perform steps that include receiving the data associated with a parameter of the crop, determining at least one action item corresponding to data associated with the parameter of the crop, and sending a signal indicating that the action item should be performed. For example, in an exemplary embodiment, the controller may receive data from sensors and/or the sensor array, determine that the crop should be watered, chemically treated, mowed, tedded, raked, baled, or allowed to rest/dry, and send a signal indicating that a respective action should be taken to a user. Further, the processor may determine that no action need be taken, and may determine an estimated wait time until a subsequent action should be performed (e.g., the controller may recognize from the crop age and crop height that the crop has been mowed, receive a moisture content indicating that the crop is not ready to be raked or baled, then analyze the change in humidity above the crop and crop moisture content to estimate a time that the crop may be ready to be raked or baled).

In other embodiments, the crop monitoring system is configured to receive additional information (e.g., a crop attribute, data associated with crop planting, weather forecasts, etc.) from a user via a user interface communicatively coupled to the controller. For example, a user inputs a crop attribute such as a crop plant date, a crop species, a crop type, a crop age, or a harvest stage indication. The crop monitoring system receives the user input and utilizes the crop attribute or input data to further monitor the crop (e.g., applies the crop attribute when determining whether the crop should be watered, mowed, tedded, raked, baled, chemically treated, etc.). For example, in some embodiments, a user inputs a crop identifier identifying the crop as alfalfa. The processor uses the identifier to determine that mowed alfalfa should be allowed to dry to, for example, a moisture content of 18%-22% before being baled. The crop monitoring sensor factors this additional information into its determination when monitoring crop moisture content to determine whether the crop should be baled (e.g., determining the crop should not be baled if a moisture content of 30% is present, estimating a dry down time for a crop at 30% moisture given a measured temperature, humidity, change in humidity, etc.).

### Exemplary Irrigation System for a Crop Monitoring System

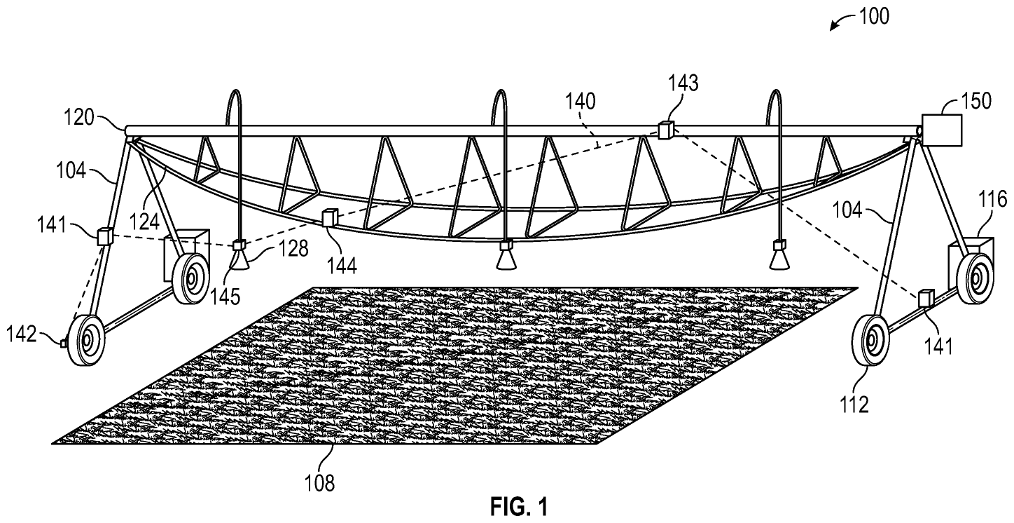

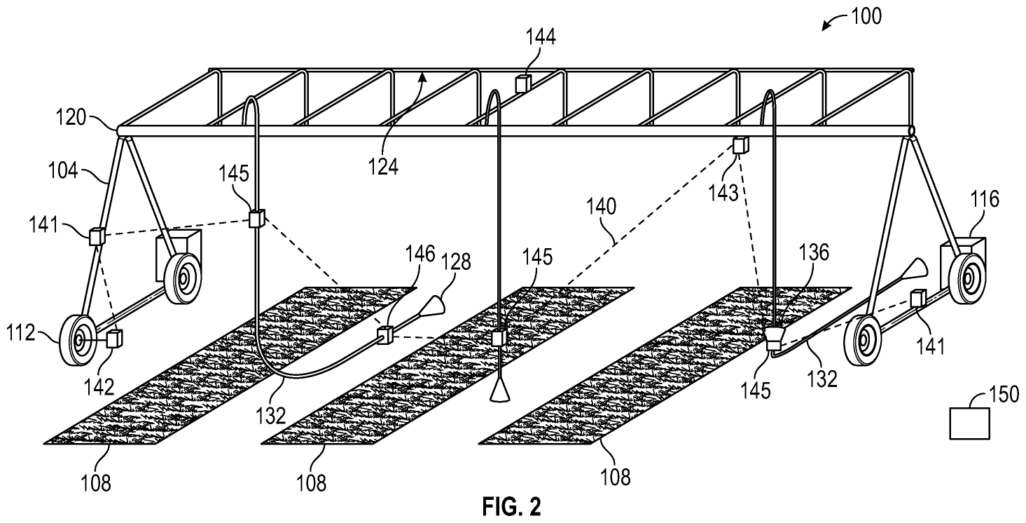

According to the exemplary embodiment shown in FIGS. 1-2, a crop monitoring system, shown as the system 100, includes a plurality of support towers 104. The support towers 104 are configured to irrigate a crop 108, for example, by supporting the components of the crop monitoring system 100 and being configured to travel across a field to provide water to the crop 108 planted therein. The support towers 104 may include subcomponents such as a frame, truss rods, truss bars, braces, cables, support wires, etc. to provide support to the crop monitoring system 100.

The crop monitoring system 100 also includes a plurality of wheels 112. Each wheel 112 is coupled to one of the support towers 104. In some embodiments, each support tower 104 is coupled to single wheel 112. In other embodiments, the support towers 104 may include one or more wheels 112, and some support towers 104 may have more or less wheels 112 than others. The wheels 112 may be rotatably fixed to the support towers 104, coupled to an axle and configured to allow the support towers 104 to maneuver along the field, or coupled in other suitable arrangements. One or more of the wheels 112 are coupled to a driving mechanism 116 (e.g., a motor, an electric motor) configured to rotate the wheels 112 and to allow the crop monitoring system 100 to travel along the field to irrigate the crop 108. The driving mechanism 116 may be coupled to the crop monitoring system 100 in a variety of suitable manners (e.g., each wheel 112 receives its own driving mechanism 116, each support tower 104 includes one driving mechanism 116 to rotate its wheels 112, etc.).

A water conduit 120 extends between the support towers 104. In various embodiments, the water conduit 120 includes a pipe, hose, pumps, a system of piping, hosing, valves, goosenecks, etc. The water conduit 120 may be coupled or otherwise fixed to the support towers 104 and extend between the support towers 104 such that the water conduit 120 travels over the crop 108. The water conduit 120 receives water from a water source such as a cistern, water tank, well, groundwater tap, ditch feed water reservoir running alongside the field, hose feed water system, etc. The water conduit 120 delivers the water from the water source, through the crop monitoring system 100 in order to water the crop 108.

A truss system 124 also extends between the support towers 104 and supports the water conduit 120. In some embodiments, the truss system 124 includes truss rods and truss bars coupled to the water conduit 120 and the support towers 104. In other embodiments, the truss system 124 includes cables, support wires, brackets, braces, hose slings, and other suitable features to support the water conduit 120. The truss system 124 may extend below the water conduit 120, above the water conduit 120, or in other positions alongside the water conduit 120 spanning between the support towers 104.

The crop monitoring system 100 also includes a plurality of nozzles 128. The nozzles 128 are fluidly coupled to the water conduit 120. For example, the nozzles 128 may be connected to the water conduit 120 via pipes, hoses, tubing, affixed directly to the water conduit 120, etc. In some embodiments, the nozzles 128 include pressurized sprayers, sprinkler heads, bubblers, or other suitable devices. In some embodiments, the nozzles 128 are configured in a mid elevation sprinkler application (MESA) configuration. For example, the nozzles 128 are coupled to the water conduit 120 via a hose and operate 5-10 feet above the ground and douse the crop 108 below with water from the water conduit 120. In other embodiments, the nozzles 128 may be coupled in a low elevation spray application (LESA) configuration. For example, the nozzles 128 are coupled to the water conduit 120 via a hose (or pipe, etc.) and operate 1 foot or less above the ground to douse the field/crop 108 with water from the water conduit. In such configuration, water lost to wind drift may be lessen as compared to high pressure sprayers or MESA configurations. In further embodiments, the nozzles 128 are coupled to the water conduit 120 in a low elevation precision application (LEPA) configuration. For example, the nozzles 128 operate at ground level (e.g., with the nozzles 128 and/or hose traveling along the ground and releasing water as the crop monitoring system 100 travels along the field). In such embodiments, the nozzles 128 are connected to a flex line or drag line 132 (shown in FIG. 2). Additionally, the nozzles 128 may be operated with a drag sock to limit water loss and prevent damage to the field, crop 108, or soil as the crop monitoring system 100 travels along the field. The nozzles 128 may also travel between the crop 108 (e.g., drag along the soil between furrow dikes) to minimize water loss and to maintain the location of the nozzles 128 in a constant/known path as the crop monitoring system 100 travels along the field.

In other embodiments, additional low drift applicators 136 are used to apply chemical treatment to the crop 108. The low drift applicators 136 are coupled, for example, to a hose at a point between the drag line 132 and the water conduit 120.

### Exemplary Systems for Crop Monitoring

Further referring to FIGS. 1-2, the crop monitoring system 100 comprises a sensor array 140 coupled to the components of the exemplary irrigation system discussed above. The sensor array 140 is configured to collect data associated with at least one parameter of the crop 108. For example, the sensor array 140 collects data indicating at least one parameter such as a crop height, a crop bloom, a crop moisture content, an air humidity content, a soil moisture content, a crop color, a crop growth stage, a crop identifier, or a soil fertilizer content. Sensors in the senor array 140 may include water potential sensors, such as tensiometers and granular matrix sensors. The sensor array 140 also includes soil moisture sensors that provide a percentage or relative content of soil moisture. In other embodiments, the sensors include image capturing devices (cameras, IR sensors, true color sensors, RGB sensors, near infrared sensors, optical crop sensors, etc.). In further embodiments, the sensor array 140 includes soil nutrient sensors (e.g., a nitrogen-phosphorus-potassium (NPK) sensor, etc.).

The sensors of the sensor array 140 are strategically mounted to the crop monitoring system in order to optimally collect respective data associated with a desired parameter of the crop. For example, in some embodiments, a first sensor 141 is coupled to one of the support towers 104. Depending on the desired data associated with a parameter of the crop to be collected, an appropriate first sensor 141 and placement on the support towers 104 can be determined. For example, as shown in FIG. 1, in some embodiments, the first sensor 141 is mounted to a vertical member of the support tower 104. Further, the first sensor 141 may be mounted to a horizontal member of the support tower 104, or another suitable component of the support tower 104. In some embodiments, the first sensor 141 is crop moisture sensor configured to collect data indicating humidity in air above the crop (e.g., a hygrometer, relative humidity/temperature sensor, sensor configured to measure a change in humidity, humidity probe, etc.). The crop moisture sensor determines the water content of the crop, a dryness level of the crop, whether the crop is at a moisture content optimal for baling, etc. In additional embodiments, the crop moisture sensor is an infrared moisture sensor configured to measure the water content, moisture percentage, volumetric water content, etc. of the crop 108.

In other embodiments, the first sensor 141 is a height sensor configured to collect data indicating a height of the crop 108. In such embodiments, the first sensor 141 is configured to determine the height of the crop 108 relative to the field, an average height of the crop 108, a tallest height of the crop 108, etc. Suitable sensors to measure crop height include multi-point height sensors, optical sensors, laser sensors, ultrasonic sensors, etc. In further embodiments, the first sensor 141 is a color sensor configured to collect data indicating a color of the crop. Suitable color sensors include optical sensors, RGB sensors, near-infrared (NIR sensors), cameras, true color sensors, etc. By determining the color of the crop, the first sensor 141 may indicate a health of the crop, a stage of crop dryness, a stage of crop bloom, a density of crop growth, an average crop health, an indication of weeds/unwanted growth, etc.

Like the first sensor 141, additional sensors (e.g., a second sensor 142, a third sensor 143, a fourth sensor 144, a fifth sensor 145) are included in the sensor array 140 in certain embodiments. The additional sensors are mounted in locations according the data associated with a parameter of the crop desired to be collected. For example, in some embodiments, the second sensor 142 is coupled to one of the wheels 112 and is a soil moisture sensor. Mounting a soil moisture sensor to one of the wheels 112 may be optimal because, as the wheel 112 rotates, the second sensor 142 contacts the soil and collects data indicating a soil moisture content, a volumetric water content, a soil tension when placed in the soil profile, etc. As shown in FIG. 2, in other embodiments, the second sensor 142 may be coupled to a rod or array attached to the wheel 112 (or a cover/fixed component of the wheel 112) that trails near or along the ground to provide constant or more frequent soil moisture readings.

In similar manners and as shown in FIGS. 1-2, a third sensor 143 is coupled to the water conduit, a forth sensor 144 is coupled to the truss system, and a fifth sensor 145 is coupled to one of the nozzles 128 (and/or low drift applicator 136). In embodiments incorporating a drag line 132 (e.g., when at least one nozzle 128 is in a LEPA configuration, travels along the field and disperses water via a drag sock, etc.) a drag line sensor 146 is coupled to the drag line 132. The drag line sensor 146 may be coupled such that the drag line sensor 146 is in contact with the ground and measures soil moisture content ahead of the nozzle 128. In other embodiments, the drag line sensor 146 is coupled to the drag line 132 at a portion of the line above the ground. In such configurations, the drag line sensor, in other words the drag line sensor 146, may measure crop height, crop color, crop bloom, crop moisture content, humidity, etc. as discussed above.

While the exemplary embodiments discussed above suggest certain sensor types used for the sensor array 140 including a first sensor 141, second sensor 142, third sensor 143, fourth sensor 144, fifth sensor 145, and drag line sensor 146, these examples should not be taken as limiting. It should be understood that the sensor types discussed above may be swapped, varied, exchanged, deployed in alternative locations, and that such variations of the sensor array are within the present disclosure. Further, the sensor array 140 may include fewer sensors or may include additional sensors depending on the desired size and span of the crop monitoring system 100 and the field/crop 108 being monitored.

The crop monitoring system 100 also includes a controller 150. As shown in FIG. 1, the controller 150 may be coupled directly to the crop monitoring system 100. As shown in FIG. 2, in other embodiments, the controller 150 may be located offsite or otherwise not be physically coupled to the crop monitoring system 100. In such embodiments, the controller 150 sends and receives data to the crop monitoring system 100 (e.g., wirelessly communicates with the crop monitoring system 100 and the sensor array 140). The controller 150 is communicatively coupled to the sensor array 140 and the sensors therein.

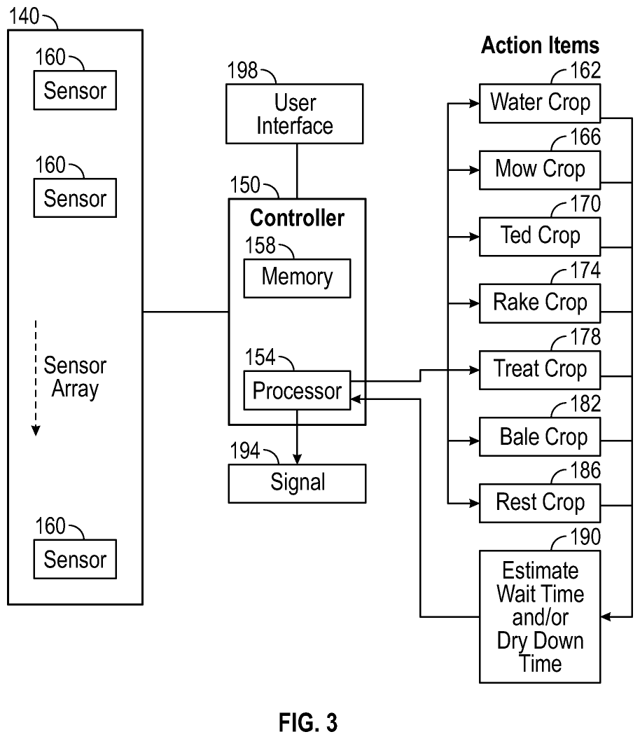

Turning to FIG. 3, the controller 150 includes a processor 154 and a memory 158. The memory 158 contains instructions that, when executed by the processor 154, cause the processor 154 to perform steps for monitoring the crop and scheduling action items 161 for crop management. In an exemplary embodiment, the crop monitoring system 100 is configured to monitor the crop 108 in order to optimize the process for mowing, raking, and baling hay.

FIG. 3 shows the controller 150 communicatively coupled to the sensor array 140 and the sensors 160 (e.g., a first sensor, 141, second sensor 142, Nth sensor, etc.) comprising the sensor array 140. The sensor array 140 collects data associated with a crop parameter (e.g., data indicating a crop height, a crop bloom, a crop moisture content, an air humidity content, a soil moisture content, a crop color, a crop growth stage, a crop identifier, or a soil fertilizer content) and communicates the data to the controller 150. The controller 150 receives the data associated with a parameter of the crop and utilizes the same to determine at least one action item 161 corresponding to the data associated with the parameter of the crop.

For example, the controller 150 may receive data and the processor 154 may analyze the data and determine whether the crop should be watered. In some embodiments, a height sensor of the sensor array 140 detects a crop height lower than an expected height at full yield. A color sensor of the sensor array 140 detects a crop color predefined as a color of the crop 108 in a growth stage. A moisture sensor of the sensor array 140 detects that the crop water content is lower than a predefined value, a soil moisture sensor of the sensor array 140 detects that soil water volume is lower than a predefined value, and/or a humidity sensor of the sensor array 140 detects a relative humidity indicating dry conditions. The processor 154 determines from the collected data that the crop should be watered or that the crop should not be watered and selects an indication that the crop should (or should not) be watered 162.

Further, the controller 150 may receive data and the processor 154 may analyze the data and determine whether the crop should be mowed. For example, in an exemplary embodiment, the sensor array 140 includes a height sensor that detects a height indicating that the crop 108 is fully grown and/or a color sensor indicating that the crop 108 has reached full maturity. The processor 154 then analyzes the data and determines whether the crop should or should not be mowed, and selects an indication that the crop should (or should not) be mowed 166. The processor 154 may additionally detect a sudden change in crop height and conclude that the crop has been mowed. In other embodiments as discussed below, the controller may be configured to receive an input indicating to the processor that the crop 108 has been mowed. In such embodiments, the processor 154 (in the case of determining the optimal schedule for baling hay) may proceed to determining whether the crop 108 should be tedded or raked.

The controller 150 also receives data and the processor 154 analyzes the data to determine whether the crop should be tedded (physically manipulating the crop to rotate the dried and green portions thereof to speed up the drying process) and/or raked (rolling the wetter crop from the bottom of the swath to the outer surface of the windrow). For example, the sensor array 140 may determine a crop height via the height sensors/optical sensors indicating that the crop has been mowed or positioned in a windrow, a crop density via optical sensors, crop color indicating dried crop, and determine that the crop is in a stage of drying out post-mowing. The processor 154 receives data indicating soil moisture, crop moisture, and humidity from the sensor array 140 and analyzes the data (e.g., compares the moisture level to a predefined amount, desired range, desired moisture over time curve, estimated drying/evaporation schedule, etc.) to determine whether the crop should be tedded or raked. The processor 154 then selects an indication that the crop should (or should not) be tedded 170 and/or an indication that the crop should (or should not) be raked 174.

In some embodiments, the processor 154 is configured to determine whether the crop should be chemically treated and to select an indication that the crop should (or should not) be chemically treated 178. For example, during the process of growing the crop and drying hay, chemical solutions may be added to the crop to eliminate weeds/unwanted plant, to speed drying, or aid in preserving hay as it dries down. Chemical treatments include potassium carbonate solution, sodium carbonate solution, herbicide, glyphosate, desiccants, buffered propionic acid, acidic solutions, etc. The sensor array 140 may include moisture sensors that determine that the hay is outside of an optimal range of dryness (e.g., the crop has a moisture content above 16%-30% moisture). The processor 154 may determine that a chemical treatment should be applied to the hay, that a desiccant should be applied to the hay, or the like. In other embodiments, the sensor array 140 may include optical sensors or color sensors that collect data indicative of the presence of unwanted plants, weeds, etc. The processor may be configured to deploy a herbicide to the crop to prevent growth of undesired foliage.

Further, the processor 154 is configured to determine whether the crop 108 (e.g., alfalfa, wheat, small grain crops, etc.) should be baled and to select an indication that the crop 108 should (or should not) be baled 182. For example, in some embodiments, the processor 154 and memory 158 are configured to store previous action items 161 and log the most recent action item 161 taken (e.g., the processor 154 and memory 158 may store data indicating that the most recent action item 161 taken was to rake the crop). The processor may then receive data indicating that the crop is in an optimal moisture range for baling (e.g., between 18% and 22% moisture content) via the moisture sensors of the sensor array 140. The processor 154 may also determine via the optical sensors and/or height sensors that the crop 108 is positioned in a windrow with sufficient density for baling. Alternatively, the processor may analyze data from color sensors of the sensor array to determine that the crop color is a color pre-defined as indicative of a baling stage. Accordingly, the processor 154 analyzes the data from the sensor array 140 and determines that the crop 108 should be baled and selects an indication that the crop should (or should not) be baled 182.

Further, in certain embodiments, the processor 154 is also configured to determine that no action should be taken and to select an indication that the crop should be allowed to rest 186. For example, should the processor 154 determine that the crop should not be watered, should not be mowed, should not be tedded, should not be raked, should not be chemically treated, and/or should not be baled, the processor 154 may select an indication that no action item 161 should be taken and that the crop should be allowed to rest before proceeding to the next task 186. In a particular embodiment, the processor 154 determines that the most recent action item 161 was to rake the crop 108, however, the processor 154 also receives data indicating that the crop 108 is not at an optimal moisture content for baling, and that the crop has already been treated with desiccants. Accordingly, the processor 154 may determine that the crop is not in a stage appropriate for baling, and select the indication that the crop should be left alone/allowed to rest 186. In other embodiments, the processor may receive data indicating that the crop height is below an optimal yield height, that the crop color is indicative of a growth stage, and that the soil moisture content is indicative of a watered crop. Accordingly, the processor 154 may determine that additional time is needed for the crop to grow before mowing, that the crop should not be watered, mowed, chemically treated, etc., and/or that the crop should be left alone/allowed to rest 186.

In further embodiments, the memory 158 contains instructions that, when executed by the processor 154, cause the processor 154 to estimating a wait time 190 until an action item 161 corresponding to data associated with the parameter of the crop should be performed. For example, upon determining that the crop should not be watered, the processer 154 may determine an estimated wait time until the crop should be watered. The processor may receive data indicative of a soil moisture content, a plant moisture content, and a temperature and determine that the crop does not need to be watered. However, the processor may estimate a wait time until the crop 108 should be watered, for example, by receiving data indicative in a change in humidity above the crop, a change in moisture of the soil, a change in water content of the crop, etc. Similar determinations can be made to estimate wait times until the crop should be mowed, tedded, raked, chemically treated, or baled. As another example, the processor may determine that a crop height is not at an optimal yield height and that the crop is not ready to be mowed. The processor may then receive data indicating a rate of change of the crop height, and estimate a time until the crop reaches a height that indicates the crop is ready to be mowed. Similarly, the processor may determine, via data from the height, moisture, color, optical sensors, etc. that the crop has been mowed and is in a wind row for drying. However, the processor may determine the crop should not be baled (e.g., because the crop moisture content is above a pre-determined threshold). The processor may receive data indicative of a rate of change in the crop moisture content (e.g., a rate of crop drying, an evaporation rate, a rate of change in humidity in the air above the crop) and estimate a wait time until the crop moisture content will be in a range suitable for baling. In certain embodiments, the processor 154 is configured to estimate a “dry down time,” i.e., an estimated wait time from mowing until the crop is in a state suitable to be baled.

The controller 150 and/or the processor 154 are further configured to send a signal 194 indicative of the action item 161 that should be performed, indicative of the estimated wait time until the next action item 161 should be performed, and/or indicative of the estimated dry down time until the crop 108 is ready to be baled. For example, the signal 194 may include a wireless communications, cellular signals, 2G, 3G, 4G, LTE, WiFi, Bluetooth Low Energy, RF signals, or other suitable signals and combinations thereof. The signal 194 may also include a listing of relevant crop parameters measured by the sensor array such as crop height, crop color, soil moisture content, crop moisture content, temperature, etc. The signal 194 may also include an indication that a suggested action item 161 be performed, an indication of the previous action item 161 that was performed, etc.

In additional embodiments, the controller 150 is configured to receive an indication of a crop attribute. The indication of a crop attribute may be received from a user interface 198 communicatively coupled to the controller 150 or the crop monitoring system 100. In some embodiments, a user manually inputs an indication of a crop attribute into the user interface 198. For example, after planting a crop 108, the user may input on the user interface that the crop is alfalfa, which may then be received by the controller 150. The controller may then access data associated with alfalfa (e.g., estimated growth time, desired moisture content of the crop before being baled, color and height associated with growth stages, desired chemical treatment conditions, etc.) to be considered by the processor 154 when the processor determines which action item 161 should be taken, estimates a wait time associated with an action item 161, or estimates a dry down time of the crop. In other embodiments, indications of a crop attribute may include, a crop age, a crop planted date, or a harvest stage indication (e.g., the crop was raked at a specific date/time; the crop has just been chemically treated, etc.).

### Exemplary Method for Crop Monitoring

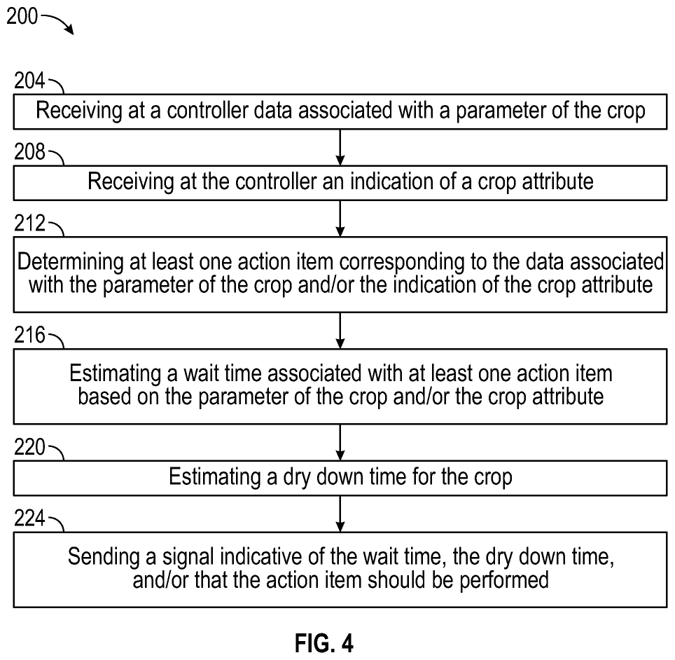

Turning to FIG. 4, a flow chart depicting exemplary steps of a method for crop monitoring 200 to determine mowing, raking, and baling times is disclosed. While the method steps in FIG. 4 are shown in a particular order, it should be understood that in alternative embodiments, the various steps may be performed in a different order, may be performed concurrently, may be performed iteratively, etc.

At step 204, data associated with a parameter of a crop is received at a controller 150 of a crop monitoring system 100. For example, in some embodiments, the data associated with a parameter of the crop includes data indicating a crop height, crop color, crop bloom, crop density, soil moisture level, crop moisture level, relative humidity, change in humidity, soil nutrient content, etc. received from sensors included in the sensor array 140. In further embodiments, data received includes temperature, weather forecasting, and other data to predict and schedule crop growth and harvesting tasks. The data may be stored in the memory 158 and may be analyzed by the processor 154.

At step 208, an indication of a crop attribute is received at the controller 150 of the crop monitoring system 100. In some embodiments, the indication of the crop attribute is received via a user input on a user interface 198 communicatively coupled to the controller 150. For example, a user may submit a date that the crop was planted, may identify a type of crop planted, may enter desired chemical treatment protocols, may enter desired moisture levels indicative that the crop should be baled, etc. In other embodiments, the indication of a crop attribute may be received from a separate system, e.g., a communication system of a windrower. In such an embodiment, the windrower may send data indicating that the crop has been mowed, raked, or tedded and aligned into a windrow such that the processor 154 considers the data when determining an estimated dry down time until the crop should be baled.

At step 212, the controller 150 determines at least one action item 161 based on the data indicating the parameter of the crop and/or data indicating the crop attribute received at the controller. For example, the controller 150 may determine whether the crop should be watered, determine whether the crop should be mowed, determine whether the crop should be tedded, determine whether the crop should be raked, determine whether the crop should be chemically treated, determine whether the crop should be baled, and/or determine whether the crop should be left alone. In an exemplary embodiment, the controller 150 receives data from the sensor array 150 indicating a crop height, a crop moisture percentage, a soil moisture content, etc. The controller also receives data indicating that the crop was planted on a certain date. The controller 150 compares the data to a predefined set of criteria, a predictive formula for optimal harvesting according to the identified crop, and/or a database of harvesting metrics to determine whether the crop should be mowed. Alternatively, the controller 150 may determine that the crop moisture content, height, and color indicate the crop is ready to be baled (e.g., the crop moisture content is between 18-22%, the height of the windrow/crop is within a threshold range, and the crop color indicates drying is complete).

At step 216, the controller 150 estimates a wait time until at least one action item 161 should be performed based on data received indicating crop parameters and/or data received indicating crop attributes. For example, the controller may receive data indicating that the crop was mowed two days prior and that a light rain has occurred. The controller may also receive data from the sensor array indicating a crop moisture level above 18-22%, a humidity rate or change in humidity rate indicating a rate of drying, a change in crop moisture indicating a rate of drying, etc. The controller 150 may use the data to calculate an estimated time until the crop moisture content is within an acceptable range for baling. Alternatively, the controller may determine that the crop moisture content at a top portion of the crop is within a sufficient range, but may detect that the soil moisture content is indicative of a damp layer of crop beneath the top layer. Accordingly, the controller may estimate a time until raking should occur (e.g., a time until the top layer is sufficiently dry and should be rotated).

At step 220, the controller 150 estimates a dry down time (e.g., an estimated time from mowing until the crop is ready to be baled) based on data received indicating crop parameters and/or data received indicating crop attributes. For example, the controller 150 may receive data indicating weather conditions, a change in crop height from the sensor array 140, and track drying conditions over a period (e.g., three days) to estimate an optimal time to bale the crop assuming that scheduled tedding, raking, and/or chemical treating is performed. The controller 150 may reference drying curves defined by various temperatures, crops, chemical treatments, weather conditions, and action items 161 taken along with parameters directly measured from the crop to estimate the dry down time, update the estimated dry down time in response to a change in conditions/parameters, etc.

At step 224, the controller 150 sends a signal indicating that an action item 161 should be performed, that an estimated wait time should elapse before an action item 161 is performed, and/or that an estimated dry down time should elapse before the crop is ready to be baled. For example, the signal may include a notification that the crop is ready to be watered, mowed, raked, tedded, baled, chemically treated, etc. Further, the controller 150 may send a signal indicating a wait time until a next action item 161 should be performed, a wait time until the crop is expected to be fully dried down, and/or indicate past or present parameters of the crop. The controller 150 may send the signal to a user interface 198, a farm vehicle (e.g. a windrower, tractor, etc.), a database, a server, a mobile device, etc.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the crop monitoring system and components thereof (e.g., support towers 104, the nozzles 128, the sensor array 140, the controller 150 etc.) as shown in the various exemplary embodiments is illustrative only. Additionally, any element disclosed in one embodiment may be incorporated or utilized with any other embodiment disclosed herein.

What is claimed is:

1. A system for crop monitoring, comprising:
a plurality of support towers configured to irrigate a crop;
a plurality of wheels, each wheel coupled to one of the plurality of support towers;
a water conduit extending between the plurality of support towers;
a truss system extending between the plurality of support towers, the truss system configured to support the water conduit;
a plurality of nozzles, each nozzle fluidly coupled to the water conduit;
a sensor array configured to collect data associated with a parameter of the crop;
a controller communicatively coupled to the sensor array, the controller comprising a processor and a memory, wherein the memory contains instructions that, when executed by the processor, cause the processor to perform steps comprising:
receiving the data associated with a parameter of the crop;
determining at least one action item corresponding to data associated with the parameter of the crop; and
sending a signal indicating that the action item should be performed.

2. The system of claim 1, wherein the sensor array includes at least one of a first sensor coupled to one of the support towers, a second sensor coupled to one of the wheels, a third sensor coupled to the water conduit, a forth sensor coupled to the truss system, and a fifth sensor coupled to one of the nozzles.

3. The system of claim 2, further comprising:
a drag line fluidly connecting the water conduit to at least one of the nozzles.

4. The system of claim 3, wherein the sensor array includes at least one of a drag line sensor coupled to the drag line.

5. The system of claim 1, wherein the parameter of the crop includes at least one of a crop height, a crop bloom, a crop moisture content, an air humidity content, a soil moisture content, a crop color, a crop growth stage, a crop identifier, or a soil fertilizer content.

6. The system of claim 1, wherein the at least one action item corresponding to data associated with the parameter of the crop includes at least one of an indication that the crop should be watered, an indication that the crop should be mowed, an indication that the crop should be tedded, an indication that the crop should be raked, an indication that the crop should be chemically treated, an indication that the crop should be baled, or an indication that the crop should be left alone.

7. The system of claim 1, wherein the memory contains instructions that, when executed by the processor, cause the processor to perform steps further comprising:
estimating a wait time until the least one action item corresponding to data associated with the parameter of the crop should be performed; and
sending a signal indicative of the wait time.

8. The system of claim 1, wherein the memory contains instructions that, when executed by the processor, cause the processor to perform steps further comprising:
receiving an indication of a crop attribute; and
estimating a dry down time for the crop.

9. The system of claim 8, wherein the crop attribute includes at least one of a crop type, a crop age, a crop planted date, or a harvest stage indication.

10. The system of claim 9, further comprising:
a user interface communicatively coupled to the controller and configured to send the indication of a crop attribute to the controller following a user input.

11. A method for crop monitoring, the method comprising:
receiving at a controller data associated with a parameter of the crop;
determining at least one action item corresponding to data associated with the parameter of the crop; and
sending a signal indicating that the action item should be performed.

12. The method of claim 11, further comprising:
estimating a wait time until the at least one action item corresponding to data associated with the parameter of the crop should be performed; and
sending a signal indicative of the wait time.

13. The method of claim 11, further comprising:
receiving at the controller an indication of a crop attribute;
estimating a dry down time for the crop.

14. The method of claim 11, wherein the indication of a crop attribute is received via a user inputting data on a user interface communicatively coupled to the controller.

15. The method of claim 11, wherein determining at least one action item corresponding to data associated with the parameter of the crop includes at least one of:
determining whether the crop should be watered;
determining whether the crop should be mowed;
determining whether the crop should be tedded;
determining whether the crop should be raked;
determining whether the crop should be chemically treated;
determining whether the crop should be baled; or
determining whether the crop should be left alone.

16. A system for crop monitoring comprising:
a plurality of support towers configured to irrigate a crop;
a plurality of wheels, each wheel coupled to one of the plurality of support towers;
a water conduit extending between the plurality of support towers;
a truss system extending between the plurality of support towers, the truss system configured to support the water conduit;
a plurality of nozzles, each nozzle fluidly coupled to the water conduit;
a soil moisture sensor coupled to at least one of the wheels and configured to measure data indicating a soil water content;
a crop moisture sensor coupled to at least one of the support towers, water conduit, truss system, or nozzles, the moisture sensor configured to collect data indicating humidity in air above the crop;
a controller communicatively coupled to the soil moisture sensor and the crop moisture sensor, the controller comprising a processor and a memory, wherein the memory contains instructions that, when executed by the processor, cause the processor to perform steps comprising:
receiving the data from the soil moisture sensor and the crop moisture sensor;
determining at least one of:
whether the crop should be watered,
whether the crop should be mowed,
whether the crop should be tedded,
whether the crop should be raked,
whether the crop should be chemically treated,
whether the crop should be baled, or
whether the crop should be left alone; and
sending a signal indicating the determination to a user interface.

17. The system of claim 16, further comprising:
a height sensor coupled to at least one of the support towers, water conduit, truss system, or nozzles, the height sensor configured to collect data indicating a height of the crop; and
wherein the controller is communicatively coupled to the height sensor, and the processor performs steps further comprising:
receiving the data from the height sensor.

18. The system of claim 16, further comprising:
a color sensor coupled to at least one of the support towers, water conduit, truss system, or nozzles, the color sensor configured to collect data indicating a color of the crop; and
wherein the controller is communicatively coupled to the color sensor, and the processor performs steps further comprising:
receiving the data from the color sensor.

19. The system of claim 16, wherein the processor performs steps further comprising:
estimating a dry down time of the crop.

20. The system of claim 16, wherein the processor performs steps further comprising:
upon determining that the crop should be left alone, estimating a wait time associated with at least one of whether the crop should be watered, whether the crop should be mowed, whether the crop should be tedded, whether the crop should be raked, whether the crop should be chemically treated, or whether the crop should be baled.
